(19) United States
(12) Patent Application Publication
(10) Pub. No.: US 2014/0244483 A1
(43) Pub. Date: Aug. 28, 2014

(54) MOBILE DEVICE AS A TIME CLOCK FOR PAYMENT

(71) Applicant: BANK OF AMERICA CORPORATION, Charlotte, NC (US)

(72) Inventors: Matthew A. Calman, Charlotte, NC (US); David M. Grigg, Rock Hill, SC (US); Carrie Anne Hanson, Charlotte, NC (US)

(73) Assignee: Bank of America Corporation, Charlotte, NC (US)

(21) Appl. No.: 13/777,646

(22) Filed: Feb. 26, 2013

(51) Int. Cl. G06Q 20/32

(52) U.S. Cl. CPC G06Q 20/3224
USPC 705/39

(57) ABSTRACT

Systems, methods, and computer program products provide for notifying service customers of a verified period of time which a service provider has been located at a service location and, based on the notification, initiate payment, and in some embodiments, automated payment, to the service provider for the services rendered. As service customers are not required to be present when service is provided or at least upon completion of the service. Moreover, the remote service customer can be assured that a service provider was present at a verified location for a specified period of time, and, based on the assurance, initiate payment to the service provider.

### FIELD OF THE INVENTION

In general, embodiments herein disclosed relate to commerce and, more specifically using the location of a mobile communication device as a time clock and/or a trigger for payment of services rendered at the location.

### BACKGROUND

In today's two-income household it is not uncommon for both partners to be working nine-to-five weekday jobs away from the home. Unfortunately, such work schedules are not conducive to having repairmen or the like render services at the house without at least one of the partners staying at home to let the repairman in, watch over the repairman to insure the service is properly performed and/or pay the repairman once services are completed. Obviously, the same dilemma holds true for an individual living by themselves and working outside the home.

An additional problem exists in instances in which the repairman charges for services based on an hourly rate or the like. Often times the individual needing the services relies on the service provider to make certain that the time spent on the job and the calculation of the amount due are accurate. In other instances, the service provider such as babysitters or the like, may rely on the individual needing the services to make certain that the time spent on the job and the calculation of the amount due are accurate.

Moreover, many service providers are reluctant to accept anything but cash for services provider, in that, accepting other forms of payment, such as checks or the like poses a risk of non-payment, i.e., the check not clearing or the like.

Therefore, a need exists to devise new and innovative ways for service providers to be paid for services rendered. Specifically, a need exists for individuals requiring service, who are not present at the service location (e.g., not at home), to be made aware of when a service provider arrives and when they depart. In this regard, the individual requiring service knows how long the service provider has rendered services. Further, a need exists for the service customer to be able to not only verify the time spent conducting the service but the quality of the service provider. In addition, a need exists for the service customers who are not present at the service location to remotely provide payment to the service provider based on verification of the service provider's presence and, in some embodiments, satisfaction of the services rendered. Additionally, in those instances in which services are provided based on an hourly rate or the like, a need exists to be able to accurately determine the amount due based on verified determination of the time spent rendered the services.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Methods, apparatus systems and computer program products are described herein that provide for notifying service customers of a verified period of time which a service provider has been located at a service location and, based on the notification, initiate payment, and in some embodiments, automated payment, to the service provider for the services rendered. In one example, the service customer is remotely located from the service location, such as the service customer is at their place of business and the service location is the customer's residence (e.g., a repairman, a house cleaner, a babysitter or the like). In this regard, the service customer can remotely verify the time period that a service provider has performed a service and remotely initiate payment to the service provider. In specific embodiments, the notifications provided to the service customers may include verification of the satisfactory completion of the service by attaching a media file to the notification that depicts or otherwise demonstrates the completed service. In other specific embodiments the verification of the time period and initiation of payment may occur automatically, without knowledge of the service customer, such that the service customer is not burdened with having to be aware of when the service provider arrives and departs from the remote service location nor initiating payment to the service provider.

A system for providing payment to a service provider defines first embodiments of the invention. The system includes a mobile communication device including a computing platform having a processor and a memory in communication with the processor. In addition, the system includes a time clock application stored in the memory of the mobile communication, executable by the processor of the mobile communication device and configured to generate and initiate wireless communication of a notification that indicates that a user of the mobile communication has been located at a designated location for a period of time. Additionally, the system includes a computing device, which may be another mobile communication device, including a computing platform having a processor and a memory in communication with the processor. Moreover, the system includes a service payment initiation application stored in the memory of the computing device, executable by the processor of the computing device and configured to receive the notification and, in response to receipt of the notification, initiate payment to the user for services rendered while the user was located at the designated location.

In specific embodiments of the system, the time clock application is further configured to generate and initiate communication of a first notification, in response to the user and the mobile communication device arriving at the designated location and generate and initiate communication of a second notification, in response to the user and the mobile communication device departing from the designated location. In other specific embodiments of the system, the mobile communication device further includes a location-determining mechanism, such as a Global Positioning System (GPS) mechanism or the like. In such embodiments of the system, the time clock application is further configured to automatically generate and initiate communication of the first and second notifications in response to the location-determining mechanism determining that the mobile communication device has arrived at the designated location and has departed from the designated location.

In other specific embodiments of the system, the time clock application is further configured to generate and initiate communication of the notification that includes an electronic invoice that indicates an amount due for the services rendered while the user was located at the designated location.

In still further specific embodiments of the system, the mobile communication device further includes at least one image capturing device. In such embodiments of the system, the time clock application is further configured to attach to the notification at least one of an image file or a video file captured by the image capturing device, wherein the image or video file indicates the services rendered while the service provider was located at the designated location.

In additional specific embodiments of the system, the service payment initiation application is further configured to initiate payment by one of Person-to-Person (P2P) payment or online payment of the user for services rendered while the service provider was located at the designated location.

In still further specific embodiments of the system, the service payment application is further configured to, in response to receiving the notification, determine the period of time. In such embodiments of the system, the service payment application may be further configured to determine the period of time based on receipt of a first time-stamped notification, communicated from the mobile communication device, in response to the user and the mobile communication device arriving at the designated location and receipt of a second time-stamped notification, communicated from the mobile communication device, in response to the user and the mobile communication device departing from the designated location. In such embodiments of the invention, the service payment initiation application may be further configured to further to determine a payment amount for the services rendered based on the determined period of time and a predetermined time-based payment rate.

A method for providing payment to a service provider defines second embodiments of the invention. The method includes receiving, by a computing device processor, a notification, from a mobile communication device, that is operable to verify that a service provider has been located at a designated location for a period of time. The method further includes, in response to receiving the notification, initiating, by a computing device processor, payment to the service provider for services rendered while the service provider was located at the designated location.

In specific embodiments of the method, receiving the notification further includes (1) receiving a first notification, from the mobile communication device, in response to the service provider and the mobile communication device arriving at the designated location and (2) receiving a second notification, from the mobile communication device, in response to the service provider and the mobile communication device departing from the designated location. In such embodiments of the method, the first and second notifications may be automatically communicated from the mobile communication device in response to location-determining mechanisms in the mobile communication device determining the location.

In still further embodiments of the method, receiving the notification further includes receiving, by a computing device processor, an electronic invoice that indicates an amount due for the services rendered while the service provider was located at the designated location.

In additional specific embodiments of the method, receiving the notification further includes receiving, by a computing device processor, at least one of an image file or a video file that indicates the services rendered while the service provider was located at the designated location.

In additional embodiments of the method, initiating payment further includes initiating, via the computing device processor, one of Person-to-Person (P2P) payment or online payment of the service provider for services rendered while the service provider was located at the designated location.

Moreover, additional embodiments of the method further include, in response to receiving the notification, determining, by a computing device processor, the period of time. In such embodiments of the method, determining the period of time may further include (1) receiving a first notification, from the mobile communication device, communicated in response to the service provider and the mobile communication device arriving at the designated location, wherein the first notification indicates an arrival time, (2) receiving a second notification, from the mobile communication device, communicated in response to the service provider and the mobile communication device departing from the designated location, wherein the second notification indicates a departure time and (3) determining, by the computing device processor, the period of time based on the arrival time and the departure time. In related embodiments the method may include determining, by the computing device processor, a payment amount for the services rendered based on the determined period of time and a predetermined time-based payment rate.

A computer program product including a non-transitory computer-readable medium having computer-executable instructions defines third embodiments of the invention. The computer-executable instructions are configured to cause a computer to implement the steps of receiving a notification, from a mobile communication device, that is operable to verify that a service provider has been located at a designated location for a period of time, and, in response to receiving the notification, initiating payment to the service provider for services rendered while the service provider was located at the designated location.

Thus, as described in more detail below methods, systems, computer programs and the like provide for notifying service customers of a verified period of time which a service provider has been located at a service location and, based on the notification, initiate payment, and in some embodiments, automated payment, to the service provider for the services rendered. As service customers are not required to be present when service is provided or at least upon completion of the service. Moreover, the remote service customer can be assured that a service provider was present at a verified location for a specified period of time, and, based on the assurance, initiate payment to the service provider.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram a system for using a mobile communication device as a time clock, notifying a service customer of the verified time period for which a service provider is located at a designated location and initiation of payment to the service payment based on the verified time period, in accordance with an embodiment of the invention;

FIG. 2 is a block diagram of a service provider's mobile communication device, in accordance with an embodiment of the invention;

FIG. 3 is a block diagram of a service customer's computing device, in accordance with an embodiment of the invention; and

FIG. 4 is a block diagram of a method for using a mobile communication device as a time clock, notifying a service customer of the verified time period for which a service provider is located at a designated location and initiation of payment to the service payment based on the verified time period, in accordance with embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Methods, apparatus systems and computer program products are described herein that provide for notifying service customers of a verified period of time which a service provider has been located at a service location and, based on the notification, initiate payment, and in some embodiments, automated payment, to the service provider for the services rendered. In one example, the service customer is remotely located from the service location, such as the service customer is at their place of business and the service location is the customer's residence (e.g., a repairman, a house cleaner, a babysitter or the like). In this regard, the service customer can remotely verify the time period that a service provider has performed a service and remotely initiate payment to the service provider. In specific embodiments, the notifications provided to the service customers may include verification of the satisfactory completion of the service by attaching a media file to the notification that depicts or otherwise demonstrates the completed service. In other specific embodiments the verification of the time period and initiation of payment may occur automatically, without knowledge of the service customer, such that the service customer is not burdened with having to be aware of when the service provider arrives and departs from the remote service location nor initiating payment to the service provider.

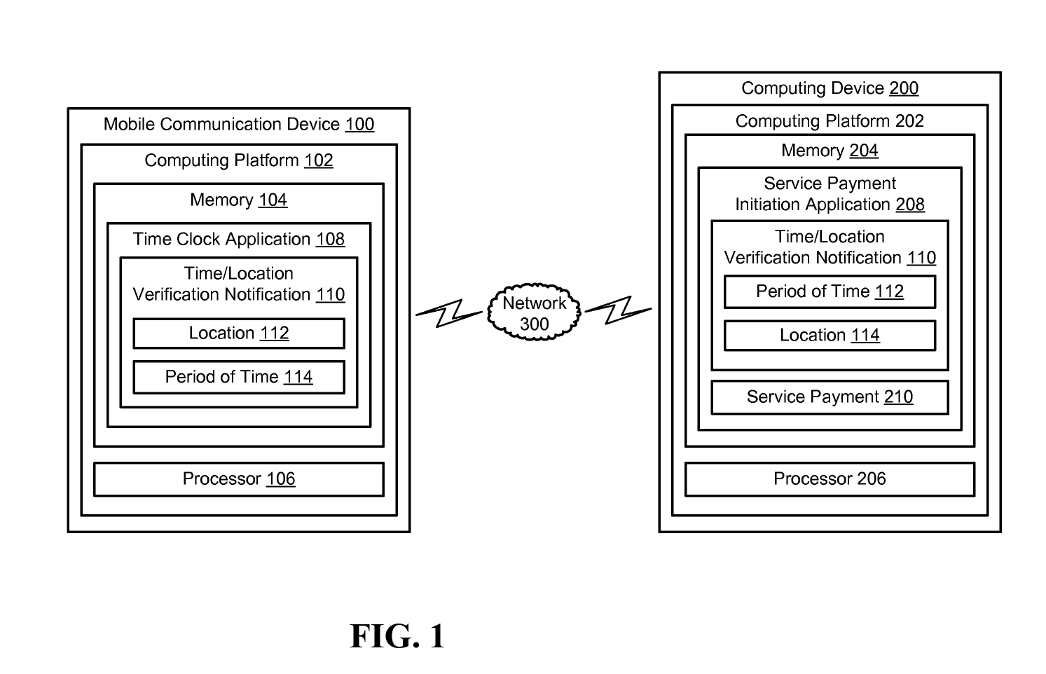

FIG. 1 illustrates a block diagram of a system for using a mobile communication device as a time clock, notifying a service customer of a verified time period at which the service provider's mobile communication device was located at a designated location and initiating payment for the services rendered at the designated location based on verified time period, in accordance with specific embodiments of the present invention. The system includes a mobile communication device 100 that is in the possession of a service provider while located a designated location at which services will be rendered. The mobile communication device will typically be a smart cellular telephone, however, in other embodiments the mobile communication device may be a personal digital assistant (PDA), a mobile Internet accessing device, a laptop/portable computer, or other mobile device capable of executing applications and communication via a wireless network 300, which may be a cellular network, and/or the Internet or the like.

The mobile communication device 100 includes a computing platform 102 having a memory 104 and at least one processor 106 in communication with the memory 104. The memory 104 stores time clock application 108 that is configured to generate and initiate wireless communication of one or more notifications 110, to a service customer, that indicates that a service provider (i.e., user) has been located at a designated location 112 for a specified period of time 114.

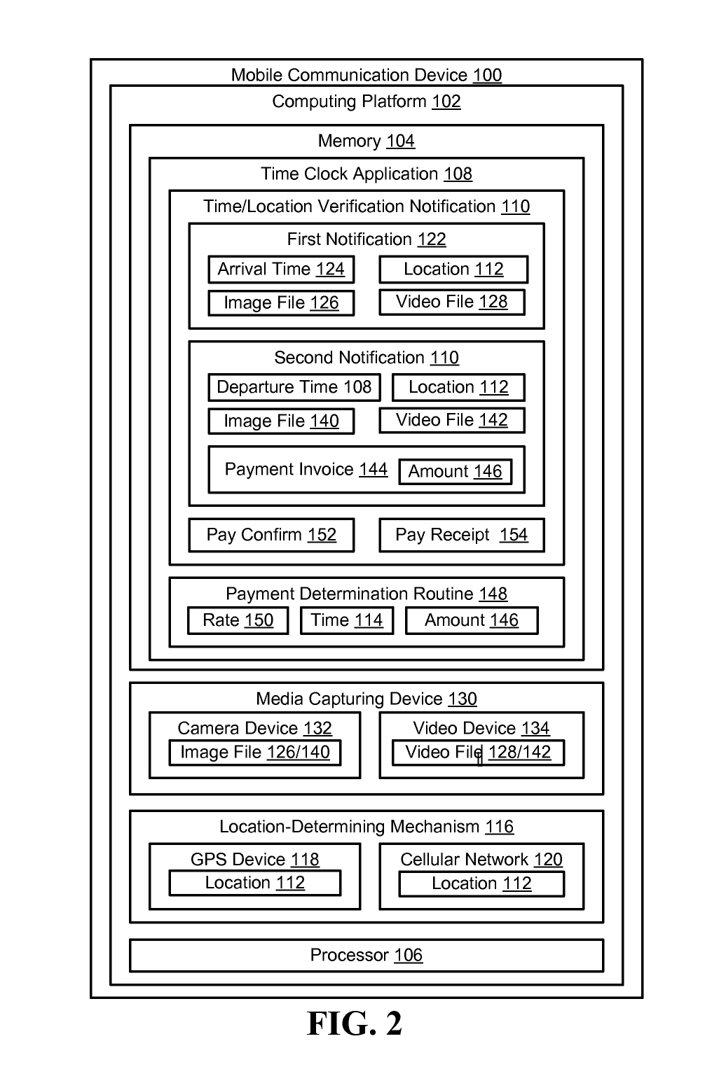

In specific embodiments of the invention, upon arriving at the designated location 112 or upon commencing the service at the designated location 112 the service provider will launch the application and perform the necessary input to “start” the time clock (i.e., record a time-stamp and the current location). The application 108 is capable of determining the location of the mobile communication device (and, thus the location of the service provider) based on the mobile communication device 100 being equipped with location-determining mechanisms (discussed in relation to FIG. 2). In other embodiments of the invention, the service provider may configure the application to automatically launch and “start” the time clock (i.e., without user input) upon the service provider arriving a designated location, which the service provider has previously designated as a time clock-required location. Such service provider configuration of the application is seen as highly beneficial in instances in which the service provider provides recurring services at a designated location, such as a house cleaner, a babysitter or the like. The time clock will automatically “stop” once the service provider, in possession of the location-determining mobile communication device 100, departs the designated location 112.

In specific embodiments of the invention the “start” and “stop” of the time clock may prompt generation and communication of a first and second notifications being sent to the service customer that indicates that the service provider has arrived (or begun the service) and departed (finished the service) at the designated location (i.e., provides indication of the time-stamp and the location), while in other embodiments a single notification is sent to the service provider upon the service provider departing the location (i.e., “stopping” the time clock), which indicates the period of time 114 based on the arrival time and the departure time at the designated location 112. The notification(s) may be sent to the service customer via email, Short Message Service (SMS) (i.e., text) or any other wireless communication channel.

The system additionally includes computing device 200 that is in the possession of a service customer who is typically, but required to be, remotely located from the service provider. The computing device 200 may be any computing device capable of executing applications and receiving communications from mobile communication device 100 via network 300. While in certain instances the computing device 200 may be a mobile computing device, such as a smart telephone or the like, the computing device 200 is not required to be a mobile communication device and, may in fact be a non-mobile computing device, such as a personal computer or the like.

The computing device 200 includes a computing platform 202 having a memory 204 and at least one processor 206 in communication with the memory 204. The memory 204 stores service payment initiation routine 208 that is configured to receive the notification 110 verifying the period of time 114 and location 112 of the service provider and, in response to receiving the notification, initiate electronic payment of a service payment 210 to the user for the services rendered while the service provider was located at the designated location.

As previously noted the notification may comprise more than one notification. For example, the notification may comprise a first notification received based on the service provider arriving or initiating the service at the designated location 112 and a second notification received based on the service provider departing from the designated location 112. Based on the difference between the arrival time and departure time the service payment initiation application can calculate the time period 114 if necessary. In other embodiments of the invention, the notification may comprise a single notification that is received by the communication device 200 upon the service provider departing the location, which indicates the period of time 114 based on the arrival time and the departure time at the designated location 112.

In certain embodiments of the invention, the service payment initiation application 208 may be configured to automatically launch upon receipt of the notification and an alert communicated to the service customer indicating that the service provider has arrived or departed from a designated location, the arrival and/or departure time, the time period for which the service provider was located at the location and any other information required for the service customer to make the proper service payment 210. In the event that the alert indicated the completion of the service, based on the service provider having departed the designated location, the alert may include a link that, upon activation by the service customer, provides for the service customer to make an electronic payment to the service provider. The link may be associated with a Person-to-Person (P2P) payment system, a third party online payment system or a financial institution payment account held by the service provider. In alternate embodiments, service customer, aware that service is scheduled to be performed for them at the designated location, may launch the service payment initiation application 200 at their bequest to check if service payment 210 is pending, based on receipt of the requisite notification verifying that the service provider was at the designated location for a period of time.

In alternate embodiments of the invention, the service payment initiation application 208 may be configured to automatically initiate service payment 210, without an action being taken by the service customer, based on receipt of the notification 110 verifying that the service provider was at the designated location for a period of time. In such embodiments further qualifications may be configured for automatic initiation of service payment 210, such as a minimum or maximum period of time required for automatic initiation of service payment 210 or the like. For example, if the service provider is a recurring service, such as house cleaning, the service customer may configure the service payment initiation application 208 to automatically initiate payment based on receipt of the notification verifying that the service provider was at the designated location 112 for a minimum period of time 114 (e.g., four hours). Thus, if the notification indicates that the service provider was at the designated location 112 for four or more hours, automatic initiation of service payment 210 occurs. However, if the notification indicates that the service provider was at the designated location 112 for less than four hours, no automatic initiation of service payment 210 is initiated an alert may be communicated to the service customer indicating such.

Referring to FIG. 2, shown is a more detailed block diagram of the mobile communication device 100, according to embodiments of the present invention. The mobile communication device 100 is configured to be implemented as a time clock for recording the time at service provider is located at a location where services are to be provided. In addition to providing greater detail, FIG. 2 highlights various alternate embodiments of the invention.

The mobile communication device 100 includes computing platform 102 that can receive and execute algorithms, such as routines, and applications. Computing platform 102 includes memory 104, which may comprise volatile and non-volatile memory, such as read-only and/or random-access memory (RAM and ROM), EPROM, EEPROM, flash cards, or any memory common to computer platforms. Further, memory 104 may include one or more flash memory cells, or may be any secondary or tertiary storage device, such as magnetic media, optical media, tape, or soft or hard disk.

Further, computing platform 102 also includes processor 106, which may be an application-specific integrated circuit (“ASIC”), or other chipset, processor, logic circuit, or other data processing device. Processor 106 or other processor such as ASIC may execute an application programming interface (“API”) (not shown in FIG. 2) that interfaces with any resident programs, such as time clock application 108 and algorithms associated therewith or the like stored in the memory 104 of the mobile communication device 100.

Processor 106 includes various processing subsystems embodied in hardware, firmware, software, and combinations thereof, that enable the functionality of mobile communication device 100 and the operability of the apparatus on the network 300. For example, processing subsystems allow for initiating and maintaining communications and exchanging data with other networked devices. For the disclosed aspects, processing subsystems of processor 104 may include any subsystem used in conjunction with time clock application 108 and related algorithms, sub-algorithms, sub-modules thereof.

Computer platform 102 may additionally include communications module (not shown in FIG. 2) embodied in hardware, firmware, software, and combinations thereof, that enables communications among the various components of the mobile communications device 100, as well as between the other networked devices. Thus, communication module may include the requisite hardware, firmware, software and/or combinations thereof for establishing a network communication connection and communicating notifications 110 to computing devices 200 in possession of service customers.

As previously noted, the memory 104 of mobile communication device 100 stores time clock application that is configured to generate and initiate wireless communication of one or more notifications 110, to a service customer, that indicates that a service provider (i.e., user) has been located at a designated location 112 for a specified period of time 114.

The application 108 is capable of determining the location of the mobile communication device (and, thus the location of the service provider) based on the mobile communication device 100 being equipped with location-determining mechanisms 116, which may include, but are not limited to for the purposes of the invention, a Global Positioning System (GPS) device 118, and/or cellular network location determining mechanisms 120 (e.g., location determination based on triangulation or the like).

As previously discussed, in specific embodiments of the invention, the time/location verification notification 110 may comprise more than one notification. A first notification 122 may be generated and communicated to the service customer's computing device 200 upon arriving at the designated location 112 or upon commencing the service at the designated location 112. Thus, the first notification may include the location 112 and the arrival time 124. In addition, the first notification may include a media file, such as image file 126 and/or video file 128 that indicates the condition of the location or the items/area requiring service prior to the service occurring. In such embodiments the image file 126 and/or video file 128 may be captured by a media capturing device 130 included within the mobile communication device 100, such as camera device 132 and/or video device 134. It should also be readily apparent that the image file 126 and/or video file 128 is not required to be included in the first notification 122 and may be sent to the service customer in a separate notification/communication.

A second notification 136 may be generated and communicated the service customer's computing device 200 upon departing from the designated location 112. Thus, the second notification may include the location 112 and the departure time 138. In addition, the second notification may include a media file, such as image file 140 and/or video file 142 that indicates the condition of the location or the items/area requiring service after the services have been performed. In this regard the image file 140 and/or video file 142 serve to provide the service customer with visual verification of the satisfactory completion of the services. The service customer may require such visual representation of the service performed prior to initiating service payment. Similar to the image files 126 and video files 128 that represent the condition of the location or the items/area requiring service prior to the service occurring, the image file 140 and/or video file 142 that represent the condition of the location or the items/area requiring service after the services have been performed is not required to be included in the second notification 136 and may be sent to the service customer in a separate notification/communication.

Additionally, the second notification 136, or a separate communication, may include a payment invoice 144 that states the payment amount 146 due. In those embodiments of the invention in which the payment amount is based on a payment rate 148, such as an hourly rate or the like, the time clock application may include a payment amount determination routine 148 configured to determine the payment amount 146 based on the predetermined payment rate 150 and the period of time 114.

The time clock application 108 may further be configured to receive a payment confirmation notification 152 communicated from the service payment initiation application 208 or an application associated with the service provider's designated payment account in response to the service customer completing electronic payment of the service provider. The payment confirmation notification 152 indicates that the payment has occurred and the amount of the payment. In such embodiments, the time clock application 108 may be further configured to generate and initiate wireless communication of a payment receipt 154 to the service customer which indicates that the payment status for the service(s) rendered and may additionally provide details as to the services performed. The payment receipt 154 may be automatically generated and communication initiated based on receipt of a payment confirmation notification 152 or the payment receipt 154 may be manually generated and communication initiated based on instructions provided/inputted by the service provider.

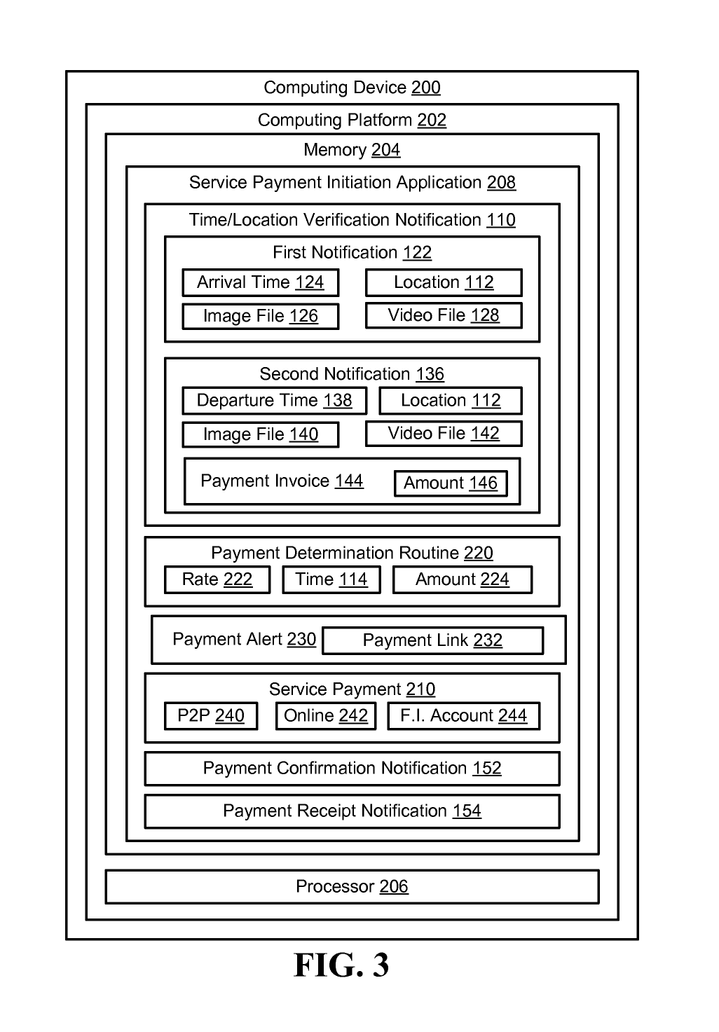

Referring to FIG. 3, shown is a more detailed block diagram of the computing device 200, according to embodiments of the present invention. The computing device 200 is configured to be implemented for initiating payment for the services rendered. In addition to providing greater detail, FIG. 3 highlights various alternate embodiments of the invention.

The mobile communication device 200, which may comprise more than one unit or devices, includes computing platform 202 that can receive and execute algorithms, such as routines, and applications. Computing platform 202 includes memory 204, which may comprise volatile and non-volatile memory, such as read-only and/or random-access memory (RAM and ROM), EPROM, EEPROM, flash cards, or any memory common to computer platforms. Further, memory 204 may include one or more flash memory cells, or may be any secondary or tertiary storage device, such as magnetic media, optical media, tape, or soft or hard disk.

Further, computing platform 202 also includes processor 206, which may be an application-specific integrated circuit (“ASIC”), or other chipset, processor, logic circuit, or other data processing device. Processor 206 or other processor such as ASIC may execute an application programming interface (“API”) (not shown in FIG. 3) that interfaces with any resident programs, such as service payment initiation application 208 and algorithms associated therewith or the like stored in the memory 204 of the computing device 200.

Processor 206 includes various processing subsystems embodied in hardware, firmware, software, and combinations thereof, that enable the functionality of computing device 200 and the operability of the apparatus on the network 300. For example, processing subsystems allow for initiating and maintaining communications and exchanging data with other networked devices. For the disclosed aspects, processing subsystems of processor 204 may include any subsystem used in conjunction with service payment initiation application 208 and related algorithms, sub-algorithms, sub-modules thereof.

Computer platform 202 may additionally include communications module (not shown in FIG. 3) embodied in hardware, firmware, software, and combinations thereof, that enables communications among the various components of the mobile communications device 100, as well as between the other networked devices. Thus, communication module may include the requisite hardware, firmware, software and/or combinations thereof for establishing a network communication connection, receiving notifications 110 and initiating electronic payment to the service provider.

As previously noted, the memory 104 of mobile communication device 100 stores service payment initiation application 208 that is configured to, in response to receiving a time/location verification notification, initiate payment for the services rendered at the location.

The time/location verification notification 110 that is received by the computing device 100 may comprise more than one notification. For example, a first notification 122 may be received in response to the service provider, in possession of the mobile communication device 100, arriving at the designated location 112 or upon commencing the service at the designated location 112. As previously discussed, the first notification 122 may include the location 112 and the arrival time 124. In addition, the first notification may include a media file, such as image file 126 and/or video file 128 that indicates the condition of the location or the items/area requiring service prior to the service occurring.

Additionally, a second notification 136 may be received in response to the service provider, in possession of the mobile communication device 100, departing from the designated location 112. Thus, the second notification may include the location 112 and the departure time 138. In addition, the second notification may include a media file, such as image file 140 and/or video file 142 that indicates the condition of the location or the items/area requiring service after the services have been performed. In this regard the image file 140 and/or video file 142 serve to provide the service customer with visual verification of the satisfactory completion of the services. The service customer may require such visual representation of the service performed prior to initiating service payment. While the media files 126, 128, 140, 142 are shown as being received in the verification notifications 110, in other embodiments of the invention they may be received in a separate notification/communication.

Additionally, the second notification 136, or a separate communication, may include a payment invoice 144 that states the payment amount 146 due and may provide further information regarding the details of the services performed at the location.

In those embodiments of the invention in which a payment invoice 144 is not received 108 or the payment amount is not otherwise known by the service payment initiation application 208, the application may implement a payment determination routine 110 to determine service payment amount 224. In those embodiments of the invention in which the service amount is based on a payment rate 222, such as an hourly rate or the like, the payment determination routine 110 may calculate the payment amount 224 based on the predetermined payment rate 222 and the period of time 114. Based on service provider and/or service customer configuration, the calculated payment amount 224 may take into the exact period of time 114 in determining the payment amount 224, such that portions of hours are billed at the payment rate 222 or portions of hours may be rounded up, such that each portion of an hour is treated as a full hour for the purpose of determining the amount due.

In certain embodiments of the invention, the service payment initiation application 208 may be configured to automatically launch upon receipt of the time/location verification notification 110 or 136 and a payment alert 230 communicated to the service customer. The payment alert may indicate that the service provider has departed from a designated location, the departure time, the time period for which the service provider was located at the location and any other information required for the service customer to make the proper service payment 210. The alert may include a link 232 that, upon activation by the service customer, provides for the service customer to make an electronic payment to the service provider. The link may be associated with a Person-to-Person (P2P) payment system 240, a third party online payment system 242 or a financial institution payment account held by the service provider 244 or the like.

In alternate embodiments, service customer, aware that service is scheduled to be performed for them at the designated location, may launch the service payment initiation application 200 at their bequest to check if service payment 210 is pending, based on receipt of the requisite notification verifying that the service provider was at the designated location for a period of time.

As previously discussed, in alternate embodiments of the invention, the service payment initiation application 208 may be configured to automatically initiate service payment 210, without an action being taken by the service customer, based on receipt of the notification 110 verifying that the service provider was at the designated location for a period of time. In such embodiments further qualifications may be configured for automatic initiation of service payment 210, such as a minimum or maximum period of time required for automatic initiation of service payment 210 or the like.

The service payment initiation application 208 may further be configured to receive a payment confirmation notification 152 communicated from an application associated with the service provider's designated payment account, in response to the successful completion of the electronic payment process. In addition, as previously discussed, a payment confirmation notification 152 is communicated to the service provider as a means of notifying the service provider that they have received payment for the services rendered. The payment confirmation notification 152 indicates, at a minimum, that the payment has occurred and the amount of the payment.

In such embodiments, the service payment initiation application 208 may be further configured, in response to the service provider receiving the payment confirmation notification 152, to receive a payment receipt 154 communicated from the service provider's mobile communication device 100, which indicates the payment status for the service(s) rendered, such as payment received in full, partial payment received, payment outstanding or the like. In addition, the payment receipt 154 may provide details as to the services performed.

In alternate embodiments of the invention, in which the service provided is a delivery, the verification notification 100 communicated from the service provider's mobile communication device may be verification of the distance travelled and/or the verification that the service provider travelled from one designated location to another designated location. In such embodiments, since time may not be relevant factor in assessing whether the service was performed (i.e., whether the delivery was performed) the verification notification may not include the start time for the delivery (i.e., when the travel commenced) and/or the time the delivery occurred (when the service provider arrives at the delivery location). In such embodiments of the invention, the service payment may be a designated flat rate payment for the delivery or the payment amount may be determined based on the verified distance travelled in making the delivery.

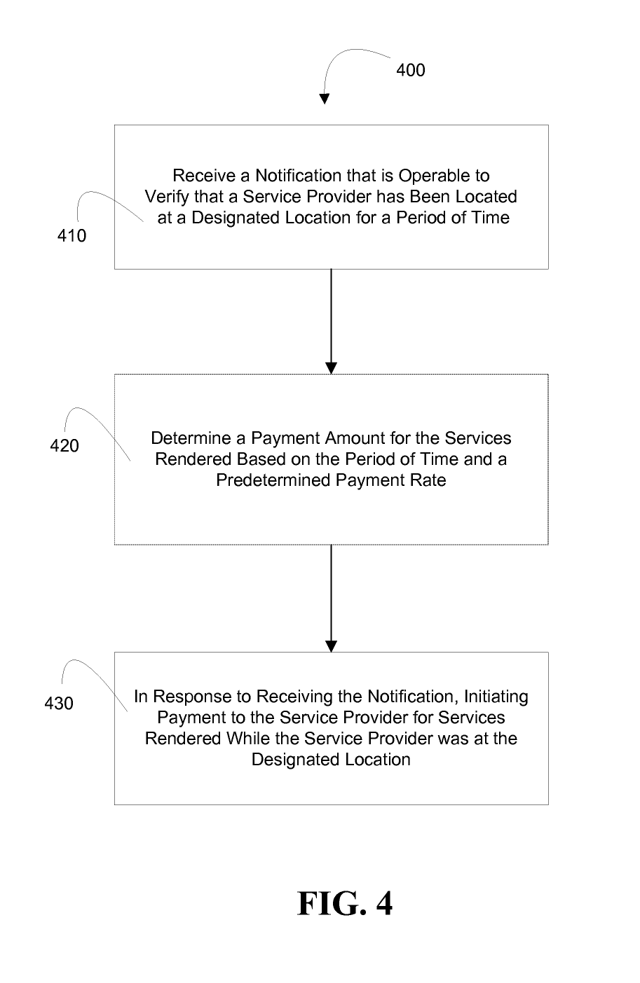

Referring to FIG. 4 a flow diagram is presented of a method 400 for using a mobile communication device as a time clock, notifying a service customer of the verified time period for which a service provider is located at a designated location and initiation of payment to the service payment based on the verified time period, in accordance with embodiment of the present invention. At Event 410, a notification is received that is operable to verify that a service provider has been located at a designated location for a period of time. The notification is sent from the service provider's mobile communication device. Verification of the location is attributed to the mobile device having location-determining mechanisms, such as GPS, cellular service location determining means or the like. In specific embodiments of the method the notification may comprise two communications; a first communication received in response to the service provider arriving at the location or commencing the service at the location, which indicated the location and arrival time, and a second communication received in response to the service provider departing from the location, which indicated the departure time. In other embodiments of the method the notification may comprise a single communication received in response to the service provider departing from the location and indicating the location and the period of time which the service provider was at the location. It should be noted that the communication sent in response to the service provider departing from the location is an automated communication (i.e., sent without the service provider providing an input) triggered by the service provider leaving the designated location.

In alternate embodiments of the method, the notification is operable to verify that a service provider travelled from one location to another location and the mileage between the locations, such as in those embodiments in which the service provider is a delivery person or the like.

In alternate embodiments of the method the notification may include a media file indicating either the condition of the area being serviced prior to providing the service or the condition of the area being serviced after completion of the services. Such a visual indication of the successful completion of the services may be required by the service customer as a condition for providing payment for the services.

In additional alternate embodiments of the method the notification, or a separate communication distinct from the notification, may include an invoice that indicates the payment amount due for the services rendered and details related to the service provide. The payment amount may be a flat fee for the services provided or the payment amount may be based on a payment rate.

If the payment amount is based on a payment rate, at optional Event 420, the payment amount may be determined for the services rendered based on the period of time at which the service provider was at the location rendering services and the predetermined payment rate. It should be noted that the payment rate may be determined by either the payment provider, prior to communicating an invoice, or by the service customer upon receipt of the notification indicating the period of time.

At Event 430, in response to receiving the notification, payment to the service provider is initiated for the services rendered while the service provider was at the designated location. The payment may be initiated by any known or future known electronic payment mechanism, such as P2P, third party online payment (e.g., PayPal® or the like), a financial institution account held by the service provider or the like. In specific embodiment of the method, the payment may be automatically initiated based on (i.e., triggered by) receipt of the notification. In such embodiments in which the initiation of the payment is automatic, the service customer may be unaware of either the receipt of the notification and/or the initiation of the payment. In additional alternate embodiments of the method, once the payment has been completed, a payment confirmation notification may be communicated to the service customer and/or the service provider. Moreover, in other additional embodiments of the method, a payment receipt may be received from the service provider. The payment receipt may be communicated in response to the service provider receiving a payment confirmation notification or some other confirmation that payment has been completed.

Thus, methods, systems, computer programs and the like have been disclosed that provide for notifying service customers of a verified period of time which a service provider has been located at a service location and, based on the notification, initiate payment, and in some embodiments, automated payment, to the service provider for the services rendered. As service customers are not required to be present when service is provided or at least upon completion of the service. Moreover, the remote service customer can be assured that a service provider was present at a verified location for a specified period of time, and, based on the assurance, initiate payment to the service provider. Moreover, such verification of location and period of time provides for initiation of payment to occur automatically, without knowledge of the service customer, such that the service customer is not burdened with having to be aware of when the service provider arrives and departs from the remote service location nor initiating payment to the service provider.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for providing payment to a service provider, the system comprising:
a mobile communication device including a computing platform comprising a processor and a memory in communication with the processor;
a time clock application stored in the memory of the mobile communication device, executable by the processor of the mobile communication device and configured to: (1) start a time clock in response to determining that the mobile communication device has arrived at a predetermined physical location, (2) stop the time clock in automatic response to determining that the mobile communication device has departed the physical location, wherein the starting and stopping of the time clock defines a period of time over which the service provider in possession of the mobile communication device has performed a service at the physical location, and (3) in automatic response to stopping the time clock, generate and initiate wireless communication of a service completed notification to a service customer that indicates that the service provider, in possession of the mobile communication device, has been located at the physical location for the period of time and completed the service, wherein the stopping of the time clock and the generating and initiating wireless communication of a service completed notification occur automatically without an input to the mobile communication device from the service provider;
a computing device including a computing platform comprising a processor and a memory in communication with the processor; and
a service payment initiation application stored in the memory of the computing device, executable by the processor of the computing device and configured to (1) receive the service completed notification, (2) in automatic response to receipt of the service completed notification, initiate payment to the service provider for the service, wherein the initiating payment occurs automatically without a service customer input, and (3) in automatic response to completing payment, generating and initiating communication of a payment confirmation notification to the mobile communication device.

2. The system of claim 1, wherein the time clock application is further configured to generate and initiate communication of a service initiated notification to the service customer, in response to determining that the mobile communication device has arrived at the predetermined physical location.

3. The system of claim 2, wherein the mobile communication device further comprises a location-determining mechanism and wherein the time clock application is further configured to automatically generate and initiate communication of the service initiated and service completed notifications in response to the location-determining mechanism determining that the mobile communication device has arrived at the predetermined physical location and has departed from the predetermined physical location.

4. The system of claim 1, wherein the time clock application is further configured to generate and initiate communication of the service completed notification, wherein the notification includes an electronic invoice that indicates an amount due for the service rendered while the service provider was located at the predetermined physical location.

5. The system of claim 1, wherein the mobile communication device further comprises at least one image capturing device and wherein the time clock application is further configured to attach to the service completed notification at least one of an image file or a video file captured by the image capturing device, wherein the image file or video file provides visual imagery of the service rendered while the service provider was located at the predetermined physical location.

6. The system of claim 1, wherein the service payment initiation application is further configured to initiate payment by one of Person-to-Person (P2P) payment or online payment of the service provider for the service rendered while the service provider was located at the predetermined physical location.

7. (canceled)

8. The system of claim 2, wherein the service payment application is further configured to determine the period of time based on receipt of the service initiated notification including a time-stamp of the start time, and receipt of the service completed notification including a time-stamp of the stop time.

9. The system of claim 8, wherein the service payment initiation application is further configured to further to determine a payment amount for the service rendered based on the determined period of time and a predetermined time-based payment rate.

10. A method for providing payment to a service provider, the method comprising:
determining, by a mobile communication device, a service start time, wherein the service start time is a time at which the mobile communication device arrives at predetermined physical location;
determining, by the mobile communication device, a service stop time, wherein the service stop time is a time at which the mobile communication device departs the predetermined physical location, wherein determining the service stop time occurs automatically without an input to the mobile communication device from the service provide;
in automatic response to determining the service stop time, generating and initiating wireless communication, by the mobile communication device, of a service completed notification to a service customer that indicates that the service provider, in possession of the mobile communication device, has been located at the predetermined physical location for a period of time defined by the service start time and service stop time and has completed a service, wherein generating and initiating wireless communication of a service completed notification occurs automatically without an input to the mobile communication device from the service provider;
receiving, by a computing device processor, the service completed notification;
in automatic response to receiving the service completed notification, initiating, by the computing device processor, payment to the service provider for the service, wherein the initiating payment occurs automatically without a service customer input; and
in automatic response to completing payment, generating and initiating communication of a payment confirmation notification to the mobile communication device.

11. The method of claim 10, wherein receiving the notification further comprises:
in response to determining the service start time, generating and initiating wireless communication, by the mobile communication device, of a service initiated notification that indicates the service start time; and
receiving, by the computing device processor, a first the service initiated notification, communicated from the mobile communication device.

12. The method of claim 11, wherein the service initiated and service completed notifications are automatically generated and communicated from the mobile communication device in response to location-determining mechanisms in the mobile communication device determining that the mobile communication device has arrived and departed from the predetermined physical location.

13. The method of claim 10, wherein receiving the service completed notification further comprises receiving, by the computing device processor, an electronic invoice that indicates an amount due for the service rendered while the service provider was located at the predetermined physical location.

14. The method of claim 10, wherein receiving the service completed notification further comprises receiving, by a computing device processor, at least one of an image file or a video file that indicates the services rendered while the service provider was located at the predetermined physical location.

15. The method of claim 10, wherein initiating payment further comprises initiating, via the computing device processor, one of Person-to-Person (P2P) payment or online payment of the service provider for the service rendered while the service provider was located at the predetermined physical location.

16. The method of claim 10, further comprising in response to receiving the service completed notification, determining, by the computing device processor, the period of time.

17. The method of claim 16, wherein determining the period of time further comprises:
receiving, by the computing device processor, a service initiated notification, from the mobile communication device, generated and communicated in response to the mobile communication device arriving at the predetermined physical location, wherein the service initiated notification indicates the time at which the mobile communication device arrived at the predetermined physical location;
receiving, by the computing device processor, the service completed notification that indicates the time at which the mobile communication departed from the predetermined physical location; and
determining, by the computing device processor, the period of time based on the time at which the mobile communication device arrived at the predetermined location and the time at which the mobile communication departed from the predetermined physical location.

18. The method of claim 16, further comprising determining, by the computing device processor, a payment amount for the service rendered based on the determined period of time and a predetermined time-based payment rate.

19. A computer program product, the computer program product comprising a non-transitory computer-readable medium having computer-executable instructions to cause a computer to implement the steps of:
determining a service start time, wherein the service start time is a time at which the mobile communication arrives at predetermined physical location;
determining a service stop time, wherein the service stop time is a time at which the mobile communication device departs the predetermined physical location, wherein determining the service stop time occurs automatically without an input to the mobile communication device from the service provide;
in automatic response to determining the service stop time, generating and initiating wireless communication, from the mobile communication device, of a service completed notification to a service customer that indicates that a service provider in possession of the mobile communication device has been located at the predetermined physical location for a period of time defined by the service start time and service stop time and has completed a service, wherein generating and initiating wireless communication of a service completed notification occurs automatically without an input to the mobile communication device from the service provider;
receiving, by a computing device processor, the service completed notification communicated from the mobile communication device;
in automatic response to receiving the service completed notification, initiating payment to the service provider for the service, wherein the initiating payment occurs automatically without a service customer input; and
in automatic response to completing payment, generating and initiating communication of a payment confirmation notification to the mobile communication device.

20. The computer program product of claim 19, wherein the step of receiving the notification further comprises:
receiving a first notification, from the mobile communication device, in response to the service provider and the mobile communication device arriving at the predetermined physical location; and
receiving a second notification, from the mobile communication device, in response to the service provider and the mobile communication device departing from the predetermined physical location.

21. The computer program product of claim 20, wherein the first and second notifications are automatically communicated from the mobile communication device in response to location-determining mechanisms in the mobile communication device determining the location.

22. The computer program product of claim 19, wherein the step of receiving the notification further comprises receiving an electronic invoice that indicates an amount due for the services rendered while the service provider was located at the predetermined physical location.

23. The computer program product of claim 19, wherein the step of receiving the notification further comprises receiving at least one of an image file or a video file that indicates the services rendered while the service provider was located at the predetermined physical location.

24. The computer program product of claim 19, wherein the step of initiating payment further comprises initiating one of Person-to-Person (P2P) payment or online payment of the service provider for services rendered while the service provider was located at the predetermined physical location.

25. The computer program product of claim 19, wherein the steps further comprise, in response to receiving the service completed notification, determining the period of time.

26. The computer program product of claim 25, wherein the step of determining the period of time further comprises:
receiving a first notification, from the mobile communication device, communicated in response to the service provider and the mobile communication device arriving at the predetermined physical location, wherein the first notification indicates an arrival time;
receiving a second notification, from the mobile communication device, communicated in response to the service provider and the mobile communication device departing from the predetermined physical location, wherein the second notification indicates a departure time; and
determining, by the computing device processor, the period of time based on the arrival time and the departure time.

27. The computer program product of claim 26, wherein the steps further comprise determining a payment amount for the service rendered based on the determined period of time and a predetermined time-based payment rate.
